(19) United States
(12) Patent Application Publication
(10) Pub. No.: US 2007/0018553 A1
(43) Pub. Date: Jan. 25, 2007

(54) Electron emission device, electron emission type backlight unit and flat display apparatus having the same

(75) Inventors: Young-Suk Cho, Suwon-si (KR); Jae-Woo Bae, Suwon-si (KR); Ik-Chul Lim, Suwon-si (KR); Yong-Soo Choi, Suwon-si (KR); Ui-Song Do, Suwon-si (KR); Dong-Hyun Kang, Suwon-si (KR); Kyu-Nam Joo, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/478,211

(22) Filed: Jun. 30, 2006

(30) Foreign Application Priority Data
Jul. 21, 2005 (KR) 2005-66379

(51) Int. Cl. H01J 1/00; H01J 9/02; H01J 19/06

(52) U.S. Cl. 313/311; 313/495; 313/310

(57) ABSTRACT

An electron emission device with improved electron emission efficiency and an electron emission type backlight unit with a new structure using the electron emission device in which an electric field between an anode electrode and a cathode electrode is effectively blocked, and electrons are emitted continuously and stably by a low gate voltage, thereby improving light-emitting uniformity and efficiency. Also provided is a flat display apparatus employing the electron emission type backlight unit having the electron emission device. The electron emission device includes a base substrate; a cathode electrode formed on the base substrate having a cross-section whose height is greater than its width; a gate electrode that is formed on the base substrate and alternately separated from the cathode electrode and has a cross-section whose height is greater than its width; and an electron emission layer disposed on a surface of the cathode electrode toward the gate electrode.

### CROSS-REFERENCE TO RELATED APPLICATIONS

This application claims the benefit of Korean Application No. 2005-66379, filed Jul. 21, 2005, in the Korean Intellectual Property Office, the disclosure of which is incorporated herein by reference.

### BACKGROUND OF THE INVENTION

1. Field of the Invention

Aspects of the present invention relate to an electron emission device, an electron emission type backlight unit, and a flat display apparatus having the same, and more particularly, to an electron emission device with improved electron emission efficiency and light-emitting uniformity, an electron emission type backlight unit employing the electron emission device, and a flat display apparatus having the electron emission type backlight unit.

2. Description of the Related Art

Generally electron emission devices can be classified into electron emission devices using a thermionic cathode and electron emission devices using a cold cathode as an electron emission source. Electron emission devices that use a cold cathode as an electron emission source include field emitter array (FEA) type devices, surface conduction emitter (SCE) type devices, metal insulator metal (MIM) type devices, metal insulator semiconductor (MIS) type devices, ballistic electron surface emitting (BSE) type devices, etc. Aspects of the present invention relate to the FEA type device.

An FEA type electron emission device uses the principle that, when a material having a low work function or a high β function is used as an electron emission source, the material readily emits electrons in a vacuum due to an electric potential. FEA devices that employ a tapered tip structure formed of, for example, Mo, Si as a main component, a carbon group material such as graphite, diamond like carbon (DLC), etc., or a nano structure such as nanotubes, nano wires, etc., have been developed.

FEA type electron emission devices can be classified into top gate types and under gate types according to the arrangement of a cathode electrode and a gate electrode. FEAs can also be classified into two-electrode, three-electrode, or four-electrode type emission devices according to the number of the electrodes.

Studies have been conducted into ways of using an electron emission device as a backlight unit of a non-emissive display device.

FIG. 1 illustrates a conventional electron emission type backlight unit 3.

Referring to FIG. 1, the conventional electron emission type backlight unit 3 includes a front panel 1 and an electron emission device 2. The front panel 1 includes a front substrate 90, an anode electrode 80 formed on a lower surface of the front substrate 90, and a phosphor layer 70 coated on the anode electrode 80.

The electron emission device 2 includes a base substrate 10 that faces and is parallel to the front substrate 90, a cathode electrode 20 formed in a strip on the base substrate 10, a gate electrode 30 formed in a strip parallel to the cathode electrode 20, and electron emission layers 40 and 50 formed around the cathode electrode 20 and the gate electrode 30. An electron emission gap G is formed between the electron emission layers 40 and 50 surrounding the cathode electrode 20 and the gate electrode 30.

A vacuum lower than the ambient air pressure is maintained in the space between the front panel 1 and the electron emission device 2, and a spacer 60 is disposed between the front panel 1 and the electron emission device 2 in order to support the pressure generated by the vacuum between the front panel 1 and the electron emission device 2 and to secure a light emitting space 103.

In the above-described electron emission type backlight unit 3, electrons are emitted from the electron emission layer 40 formed at the cathode electrode 20 by an electric field generated between the gate electrode 30 and the cathode electrode 20. The emitted electrons travel toward the gate electrode 30 initially and then are pulled by the strong electric field of the anode electrode 80 and move toward the anode electrode 80.

However, an electric field formed between the anode electrode 80 and the cathode electrode 20 interferes with the electric field formed between the gate electrode 30 and the cathode electrode 20 and thus a diode discharge, that is, electron emission and electron acceleration occurring at the same time due to the electric field of the anode electrode 80, is likely to occur. When a diode discharge occurs, the current density emitted by controlling the voltage applied to the gate electrode 30 cannot be controlled.

In addition, due to the light-emitting characteristic of phosphor materials, when light is emitted by electrons that are incident on a phosphor material, other incident electrons cannot contribute to light emitting. Thus light-emitting efficiency is not improved by increasing incident electrons on the phosphor layer 70 beyond this saturation level and an electron emission by a high anode voltage is detrimental from an energy efficiency aspect. In other words, electrons must be emitted stably and efficiently by a low gate voltage and at the same time the emitted electrons must be uniformly accelerated by a strong anode voltage. However, when electrons are emitted by a strong anode voltage, efficient electron emission and light emitting become impossible. Thus an electron emission type backlight unit with a new structure in which an electric field between the anode electrode 80 and the cathode electrode 20 can be blocked is required.

### SUMMARY OF THE INVENTION

Aspects of the present invention provide an electron emission device with improved electron emission efficiency and an electron emission type backlight unit with a new structure using the electron emission device in which an electric field between an anode electrode and a cathode electrode is effectively blocked, and electrons are emitted continuously and stably by a low gate voltage, thereby improving light-emitting uniformity and light-emitting efficiency.

Aspects of the present invention also provide a flat display apparatus employing the electron emission type backlight unit.

According to an aspect of the present invention, there is provided an electron emission device comprising: a base substrate; a cathode electrode that is formed on the base substrate and having a cross-section whose height is greater than its width; a gate electrode that is formed on the base substrate and alternately separated from the cathode electrode, and having a cross-section whose height is greater than its width; and an electron emission layer disposed on a surface of the cathode electrode toward the gate electrode.

While not required in all aspects, the electron emission layer may be formed on both sides of the cathode electrode.

While not required in all aspects, an insulating layer having a predetermined thickness may be formed between the cathode electrode and the gate electrode.

While not required in all aspects, the height of the cathode electrode and the height of the gate electrode may be substantially equal and the combined height of the insulating layer and the electron emission layer is substantially equal to the height of the cathode electrode and the gate electrode or the height of the cathode electrode and the height of the gate electrode may be substantially equal, where the height of the cathode electrode and the gate electrode is greater than the combined height of the insulating layer and the electron emission layer, and thus the electron emission layer is not formed in a portion of the upper end of the cathode electrode.

While not required in all aspects, the cathode electrode and the gate electrode may be formed in strips. Protrusions may be formed to a predetermined length and width on the cathode electrode. Concaves corresponding to the protrusions in the cathode electrode may be formed to a predetermined length and width in the gate electrode.

While not required in all aspects, a concave recess may be formed to a predetermined length and width in the cathode electrode and a protrusion corresponding to the concave recess formed in the cathode electrode may be formed on the gate electrode.

While not required in all aspects, a curved surface with a predetermined curvature may be formed in the cathode electrode. The curved surface may be convex toward the gate electrode. The curved surface may be concave toward the gate electrode. A curved surface corresponding to the curved surface of the cathode electrode may be formed in the gate electrode.

While not required in all aspects, both curved surfaces of the cathode electrode may be symmetrical around the center of the cathode electrode.

While not required in all aspects, the curved surface may be formed continuously along the cathode electrode.

While not required in all aspects, the electron emission layer may comprise an electron emission material selected from one of a group of carbon type materials comprising carbon nanotubes, graphite, diamond, and diamond-like carbon or one of a group of nano materials comprising nanotubes, nano wires, nanorods, and nanoneedles.

While not required in all aspects, the electron emission layer may be formed discontinuously at a side of the cathode electrode.

According to another aspect of the present invention, there is provided an electron emission type backlight unit comprising: a front substrate comprising an anode electrode and a phosphor layer; a base substrate separated from the front substrate by a predetermined distance; a plurality of cathode electrodes that are formed on the base substrate, each of the cathode electrodes having a cross-section whose height is greater than its width; a plurality of gate electrodes that are alternately formed on the base substrate and separated from the cathode electrodes, each of the gate electrodes having a cross-section whose height is greater than its width; an electron emission layer formed at a side of the cathode electrodes toward the gate electrodes; and a spacer maintaining a distance between the front substrate and the base substrate.

According to another aspect of the present invention, there is provided a flat display apparatus comprising: an electron emission type backlight unit comprising: a front substrate comprising an anode electrode and a phosphor layer; a base substrate separated from the front substrate by a predetermined distance; a plurality of cathode electrodes that are formed on the base substrate, each of the cathode electrodes having a cross-section whose height is greater than its width; a plurality of gate electrodes that are alternately formed on the base substrate and separated from the cathode electrodes, each of the gate electrodes having a cross-section whose height is greater than its width; an electron emission layer formed at a side of the cathode electrodes toward the gate electrodes; a spacer maintaining a distance between the front substrate and the base substrate; and a non-emissive display device that is formed in front of the electron emission type backlight unit and controls the light supplied from the electron emission device to realize an image.

While not required in all aspects, the non-emissive display device may be a liquid display device.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional electron emission type backlight unit;

FIG. 2 is a perspective view of an electron emission type backlight unit according to an embodiment of the present invention;

FIG. 3 is a cross-sectional view of the electron emission type backlight unit of FIG. 2 cut along a line III-III;

FIGS. 4 through 8 are cross-sectional views illustrating an electron emission device constituting an electron emission type backlight unit, according to various embodiments of the present invention;

FIG. 9 is a cross-sectional plan view of the electron emission device of FIG. 3 cut along a line IX-IX;

FIGS. 10 through 15 are cross-sectional plan views illustrating electron emission devices constituting an electron emission type backlight unit, according to various embodiments of the present invention;

FIG. 16 is a perspective view of a flat display apparatus according to an embodiment of the present invention;

FIG. 17 is a partial cross-sectional view of the flat display apparatus of FIG. 15 cut along a line XVII-XVII; and

FIG. 18 is a plan view of an image display device according to an embodiment of the present invention.

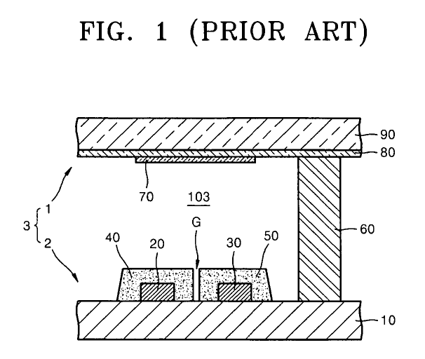

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

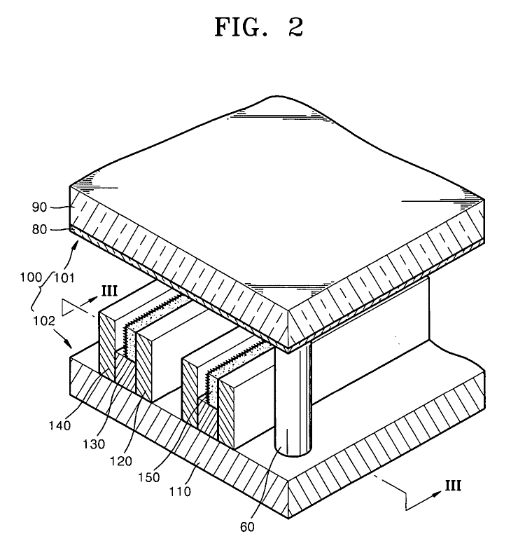

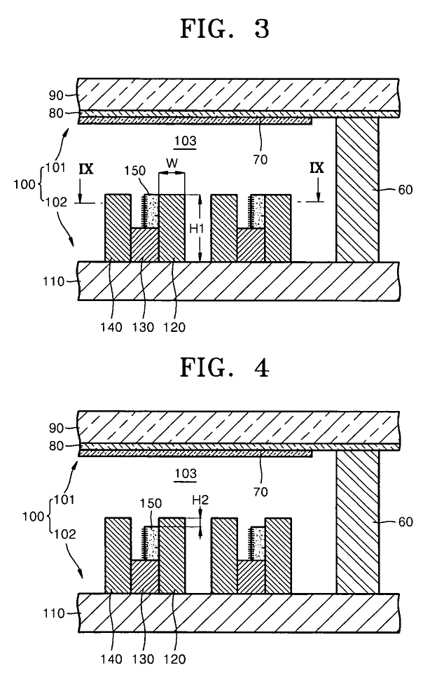

FIG. 2 is a perspective view of an electron emission type backlight unit 100 according to an embodiment of the present invention. FIG. 3 is a cross-sectional view of the electron emission type backlight unit 100 of FIG. 2 cut along a line III-III.

Referring to FIGS. 2 and 3, the electron emission type backlight unit 100 includes a front panel 101 and an electron emission device 102 that are separated from and parallel to each other. A vacuum space 103 is formed between the front panel 101 and the electron emission device 102, and a spacer 60 maintains a distance between the front panel 101 and the electron emission device 102.

The front panel 101 includes a front substrate 90, an anode electrode 80 disposed on a lower surface of the front substrate 90, and a phosphor layer 70 (see FIG. 3) disposed on a lower surface of the anode electrode 80.

The electron emission device 102 includes a base substrate 110 disposed at a predetermined interval from and parallel to the front substrate 90 whereby the vacuum space 103 is formed between the front panel 101 and the electron emission device 102, a cathode electrode 120 formed on a surface of the base substrate 110, a gate electrode 140 separated from and parallel to the cathode electrode 120, and an electron emission layer 150 disposed at a side of the cathode electrode 120 to face the gate electrode 140.

The cathode electrode 120 and the gate electrode 140 may have the same size and a height H1 thereof may be greater than a width W. When there are more than one, the cathode electrode 120 and the gate electrode 140 are alternately disposed on the base substrate 110. The cathode electrode 120 and the gate electrode 140 form an electric field so that electrons can be easily emitted from the electron emission layer 150.

The cathode electrode 120 and the gate electrode 140 extend toward the anode electrode 80 such that an electric field formed between the anode electrode 80 and the cathode electrode 120 is prevented from interfering with the electron emission layer 150. Thus the electron emission is controlled by the voltage applied to the gate electrode 140 and the electric field formed by the anode electrode 80 only accelerates the emitted electrons. Thus the electron emission efficiency and the light-emitting efficiency of the phosphor layer can be improved, thereby also improving the electron emission uniformity and the light-emitting uniformity.

While not required in all aspects, an insulating layer 130 having a predetermined thickness may be further formed between the cathode electrode 120 and the gate electrode 140. The insulating layer 130 insulates the electron emission layer 150 and the gate electrode 140 and prevents a short circuit between the gate electrode 140 and the cathode electrode 120. The insulating layer 130 is disposed to be half the height of the cathode electrode 120 and the gate electrode 140. The electron emission layer 150 is formed at a side of the cathode electrode 120 toward the gate electrode and the combined height of the insulating layer 130 and the electron emission layer 150 is substantially the same as the height of the cathode electrode 120.

The vacuum space 103 between the front panel 101 and the electron emission device 102 is maintained at a pressure lower than the ambient air pressure, and the spacer 60 is disposed between the front panel 101 and the electron emission device 102 to support the pressure between the front panel 101 and the electron emission device 102 generated due to a vacuum and to partition the vacuum space 103. The spacer 60 is formed of an insulating material such as ceramics or glass that is not electrically conductive. Electrons may accumulate on the spacer 60 during the operation of the electron emission type backlight unit 100, and to emit these accumulated electrons, the spacer 60 may be coated with a conductive material.

Hereinafter, materials of components that constitute the above-described electron emission backlight unit 100 will be described.

While not required in all aspects, the front substrate 90 and the base substrate 110 are board members having a predetermined thickness and may be formed of a quartz glass, a glass including an impurity such as a small amount of Na, a flat glass, a glass substrate coated with SiO₂, an oxide aluminum substrate or a ceramic substrate.

While not required in all aspects, the cathode electrode 120 and the gate electrode 140 may be formed of general conductive materials. Examples of the general conductive materials include a metal (e.g., Al, Ti, Cr, Ni, Au, Ag, Mo, W, Pt, Cu, Sn, Sb, In, or Pd) or its alloy, a conductive material formed of either metal such as Pd, Ag, RuO₂, Pd—Ag or its oxide and glass, a transparent conductive material such as indium tin oxide (ITO), In₂O₃ or SnO₂, and a semiconductor material such as polysilicon.

While not required in all aspects, the electron emission layer 150 which emits electrons due to an electric field may be formed of any electron emission material that has a small work function and a high β function. Carbon type materials such as carbon nanotubes (CNT), graphite, diamond and diamond-like carbon or nano materials such as nanotubes, nano wires, nanorods, or nanoneedles may be preferable. CNTs particularly have a good electron emission property and can be driven at a low voltage. Therefore, devices using CNTs as an electron emission material can be applied to a larger electron emission display device.

The above-described electron emission type backlight unit 100 operates as follows.

For the electron emission, a negative (−) voltage is applied to the cathode electrode 120 and a positive (+) voltage is applied to the gate electrode 140 to emit electrons from the electron emission layer 150 formed on the cathode electrode 120. Also, a strong (+) voltage is applied to the anode electrode 80 to accelerate the electrons emitted toward the anode electrode 80. Thus electrons are emitted from the electron emission materials that form the electron emission layer 150 and travel toward the gate electrode 140 and are then accelerated toward the anode electrode 80. The electrons accelerated toward the anode electrode 80 collide with the phosphor layer 70 at the anode electrode 80 and thus generate visible light.

Since the cathode electrode 120 and the gate electrode 140 are formed having a height extending significantly toward the anode electrode 80, the electric field formed by the anode electrode 80 can be prevented from interfering with the electric field between the cathode electrode 120 and the gate electrode 140. Thus the anode electrode 80 only accelerates the electrons, making it easy to control the electron emission with the gate electrode 140, and thus maximizing the light-emitting uniformity and the light-emitting efficiency of the phosphors and preventing diode discharge.

Hereinafter, other example embodiments of the electron emission device 102 illustrated in FIGS. 2 and 3 will be described.

FIGS. 4 through 8 are cross-sectional views illustrating electron emission devices constituting an electron emission type backlight unit, according to various embodiments of the present invention.

As illustrated in FIG. 4, in the electron emission type backlight unit 100 of FIG. 3, the height of the cathode electrode 120 and the gate electrode 140 may be increased by a distance H2 toward the anode electrode 80 such that the electron emission layer 150 is not formed at an end of the cathode electrode 120. Alternatively, the electron emission layer 150 may be disposed below the cathode electrode 120 and the gate electrode 140 ends by a predetermined distance such that the electron emission layer 150 is not formed at an end of the cathode electrode 120. Thus a diode discharge between the cathode electrode 120 and the anode electrode 80 due to an electric field of the anode electrode 80 can be prevented.

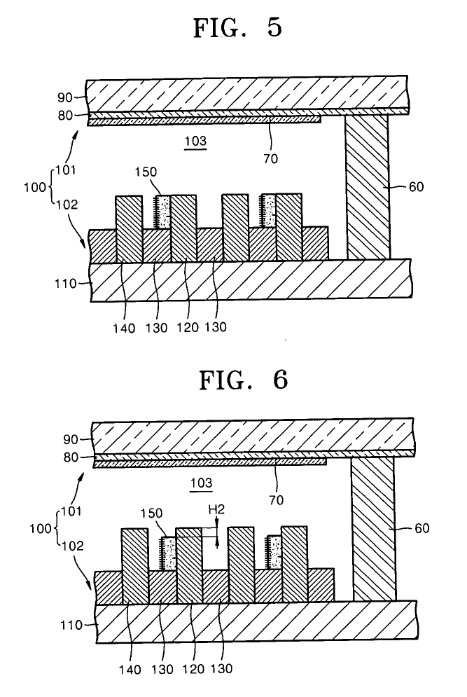

FIG. 5 illustrates another example embodiment of the present invention. As illustrated in FIG. 5, an insulating layer 130 may be formed on both sides of each of the cathode electrodes 120 and each of the gate electrodes 140. The insulating layer 130 secures insulation between each of the electrodes and efficiently prevents a short circuit between the cathode and gate electrodes.

FIG. 6 illustrates another example embodiment of the present invention. As illustrated in FIG. 6, an insulating layer 130 is formed between each of the cathode electrodes 120 and the gate electrodes 140 and the height of the cathode electrode 120 and the gate electrode 140 is increased by a distance H2 such that the electron emission layer 150 is not formed at an end of the cathode electrodes 120. Otherwise, the height of the electron emission layer 150 may be lower than the end of the cathode electrodes 120. Moreover, an improved field blocking effect and prevention of a short circuit between the cathode and gate electrodes can be obtained in the present embodiment as in the embodiments of FIGS. 4 and 5.

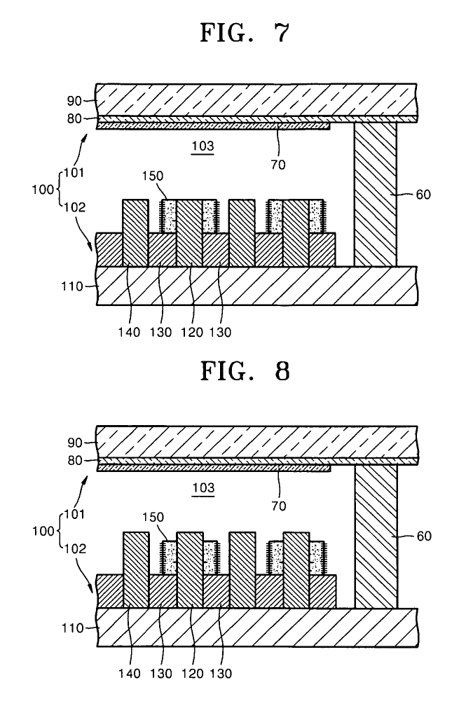

FIG. 7 illustrates another example embodiment of the present invention. As illustrated in FIG. 7, an electron emission layer 150 and an insulating layer 130 may be formed on both sides of each of the cathode electrodes 120. When an electron emission layer 150 is formed on both sides of the cathode electrode 120, more electrons can be emitted and thus required visible light can be generated at a lower power, thereby increasing the light-emitting efficiency. In this case, the insulating layer 130 may be disposed between each of the cathode and gate electrodes to prevent a short circuit therebetween.

FIG. 8 illustrates another example embodiment of the present invention. As illustrated in FIG. 8, the insulating layer 130 and the electron emission layer 150 are disposed on both sides of each of the cathode electrodes 120 and there may be an upper portion of the cathode electrodes 120 where the electron emission layer 150 is not disposed. In other words, an end of the cathode electrode 120 may extend farther than the insulating layer 130 plus the emission layer 150, or the electron emission layer 150 may be shorter such that the insulating layer 130 and the electron emission layer 150 are shorter than the cathode 120. Thus the electron emission surface can be increased, and a diode discharge can be prevented by an anode field blocking, and a short circuit between each of the cathode and gate electrodes can be prevented.

Hereinafter, other example embodiments of the electron emission type backlight unit 100 illustrated in FIGS. 3 through 8 will be described.

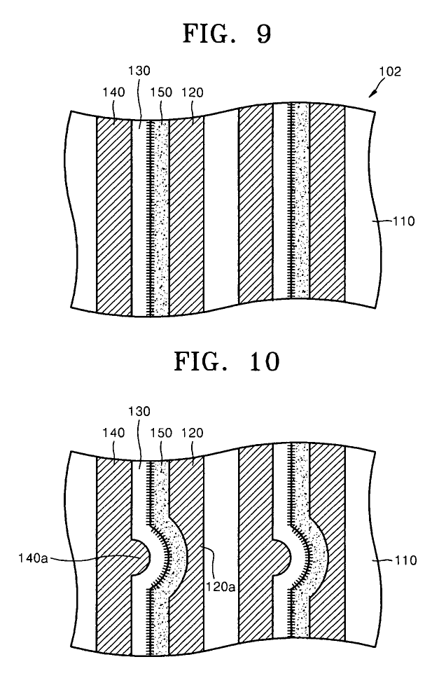

FIG. 9 is a cross-sectional plan view of the electron emission device 102 of FIG. 3 cut along a line IX-IX; FIGS. 10 through 15 are cross-sectional plan views illustrating electron emission devices constituting an electron emission type backlight unit, particularly showing various shapes of the electrode and the electron emission layers 150 of FIG. 9, according to various embodiments of the present invention. While not required in all aspects, it is understood that each of the example embodiments shown in FIGS. 4 through 8 can further embody the features of the invention exhibited in FIGS. 10 through 15.

As illustrated in FIG. 9, the cathode electrode 120 and the gate electrode 140 may be strips disposed parallel to each other. Also, protrusions, concaves, or curved surfaces may be formed in the cathode electrode 120 and the gate electrode 140 to increase the surface area of the electron emission layer 150, as illustrated in FIGS. 10 through 13.

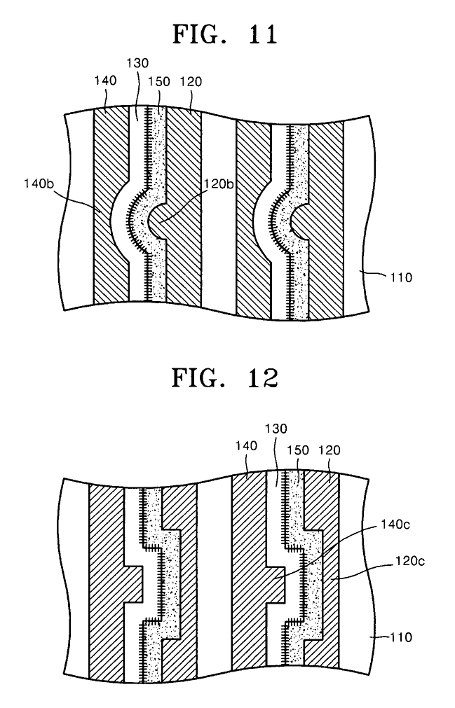

That is, as illustrated in FIGS. 10 and 11, the cathode electrode 120 includes curved surfaces 120a and 120b having a predetermined curvature at the gate electrode 140, and the electron emission layer 150 may be formed in the curved surfaces 120a and 120b. The curved surfaces 120a and 120b may be concave surfaces 120a (see FIG. 10) toward the gate electrode 140 or convex surfaces 120b (see FIG. 11) toward the gate electrode 140. In this case, curved surfaces 140a and 140b corresponding to the curved surfaces 120a and 120b may be formed in the gate electrode 140.

Also, as illustrated in FIG. 12, the cathode electrode 120 includes a concave 12c having a predetermined length and width at the gate electrode 140, and an electron emission layer 150 may be formed in the concave 120c. Then, a protrusion 140c is formed in the gate electrode 140 corresponding to the shape of the concave 120c formed in the cathode electrode 120.

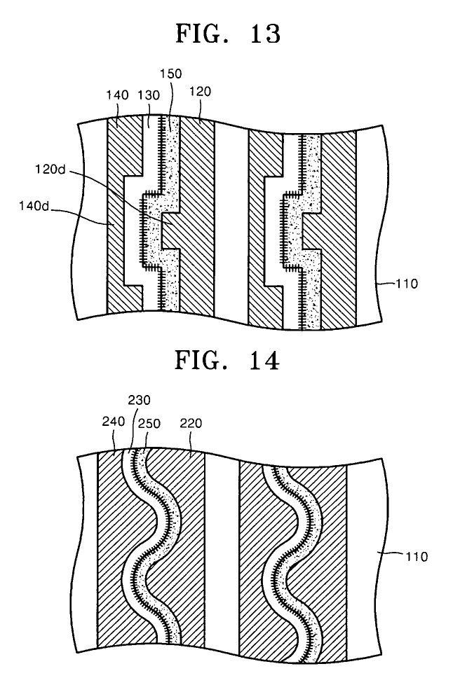

Alternatively, as illustrated in FIG. 13, the cathode electrode 120 includes a protrusion 120d and an electron emission layer 150 may be formed on the protrusion 120d. Then, a concave 140d is formed in the gate electrode 140 corresponding to the shape of the cathode electrode protrusion 120d.

The shape of the concaves and protrusions formed in the cathode electrode 120 and the gate electrode 140 is not limited to a rectangular shape and may be a trapezoidal shape or other polygonal shape.

As illustrated in FIG. 14, a continuously curved surface may be formed on a surface in which a cathode electrode 220 and a gate electrode 240 face each other. Then the surface area of the cathode electrode 220 and the gate electrode 240 with respect to the same length of the electrodes can be maximized and the surface area of the electron emission layer 250 can be increased. Accordingly, in the electron emission type backlight unit including the cathode electrode 220 and the gate electrode 240 with a continuous curved surface, the current density is increased with respect to the same voltage and thus the amount of visible light can be increased.

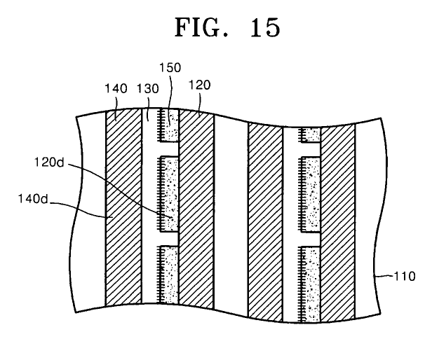

As illustrated in FIG. 15, the electron emission layers 150 on the cathode electrode 120 may be discontinuously formed with a predetermined distance therebetween. In this case, the amount of the electron emission material for the electron emission layers 150 can be reduced. In other words, the phosphor layer emits visible light in proportion to the current density to a certain saturation level of the current density, but over the certain saturation current density, the visible light intensity ceases to increase and visible light emission efficiency is lost. Accordingly, unnecessary consumption of the electron emission material can be reduced by optimizing the current density which maximizes the visible light efficiency in the phosphor layer. Also, when it is difficult to manufacture a continuous electron emission layer 150, the electron emission layer 150 can be manufactured in discontinuous portions and still achieve the various benefits described according to aspects of the present invention.

While not required in all aspects, the above-described electron emission type backlight unit 100 may be used as a backlight unit for a liquid crystal display, and in this case, the cathode electrode 120 and the gate electrode 140 are substantially disposed parallel to each other. Also, the phosphor layer may be formed of a phosphor emitting visible light of a desired color or a mix of red, green, and blue light emitting phosphors in a proper ratio to obtain white light.

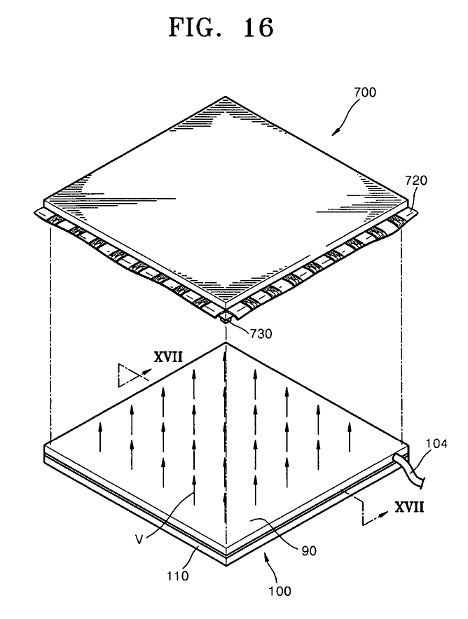

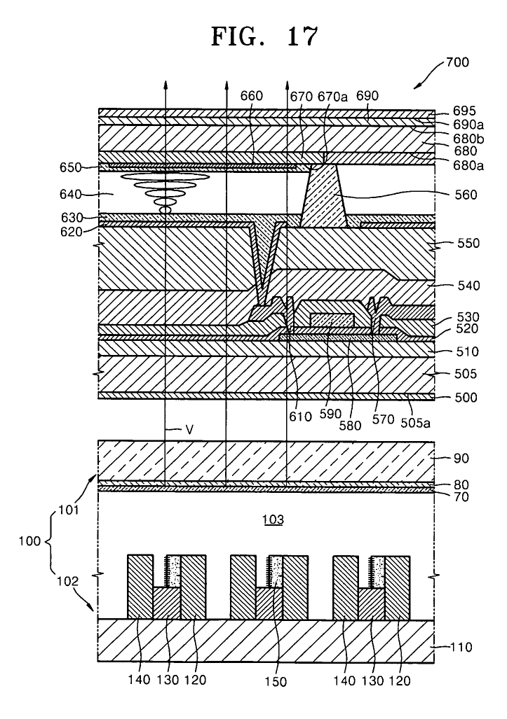

FIG. 16 is a perspective view of a flat display apparatus according to an embodiment of the present invention. FIG. 17 is a partial cross-sectional view of the flat display apparatus of FIG. 16 cut along a line XVII-XVII. Meanwhile, common terms like a gate electrode and a spacer which are used in the description of the electron emission type backlight unit 100 above are also used hereinafter additionally, for members of a liquid crystal display device. However, the terms can be distinguished by reference numerals depending on whether they are used for the electron emission type backlight units or for the liquid crystal display device.

As illustrated in FIG. 16, the flat display apparatus of the present embodiment is a non-emissive display device including a liquid crystal display device 700 and a backlight unit 100 supplying light to the liquid crystal display device 700. A soft print circuit board 720 to transmit an image signal is attached to the liquid display device 700, and a spacer 730 is disposed to maintain a distance from the backlight unit 100 disposed at the back of the liquid crystal display device 700. Although only one spacer 730 is shown in FIG. 16, additional spacers 730 may be arranged to maintain the distance between the backlight unit 100 and the liquid crystal display device 700.

The backlight unit is one of the electron emission type backlight units 100 according to the previous embodiments of the present invention, and is supplied with power through a connection cable 104, and emits visible light V through the front panel 90 to supply the visible light V to the liquid crystal display device 700.

Hereinafter, the structure and the operation of the flat display apparatus of the present embodiment will be described with reference to FIG. 17.

The electron emission type backlight unit 100 illustrated in FIG. 17 may be one of the backlight units 100 according to the previously described embodiments of the present invention. As illustrated in FIG. 17, the electron emission type backlight unit 100 is formed of a front panel 101 and an electron emission device 102 which are separated from each other by a predetermined distance. The front panel 101 and the electron emission type device 102 of the present embodiment have the same structure as those of the previously described embodiments, and thus detailed descriptions thereof will not be repeated. The electric field formed by the cathode electrode 120 and the gate electrode 140 installed in the electron emission device 102 causes electrons to be emitted. The electrons are accelerated by the electric field formed by the anode electrode 80 installed on the front panel 101 and the electrons collide with the phosphor layer 70, thus generating visible light V. The visible light V travels toward the liquid crystal display device 700.

The liquid crystal display device 700 includes a front substrate 505, and a buffer layer 510 is formed on the front substrate 505, and a semiconductor layer 580 is formed in a predetermined pattern on the buffer layer 510. A first insulating layer 520 is formed on the semiconductor layer 580, and a gate electrode 590 is formed on the first insulating layer 520 in a predetermined pattern. A second insulating layer 530 is formed on the gate electrode 590. After the second insulating layer 530 is formed, the first and second insulating layers 520 and 530 are etched using a process such as dry etching and thus a portion of the semiconductor layer 580 is exposed and a source electrode 570 and a drain electrode 610 are formed in a predetermined area including the exposed portion of the semiconductor layer 580. After the source electrode 570 and the drain electrode 610 are formed, a third insulating layer 540 is formed, and a planarization layer 550 is formed on the third insulating layer 540. A first electrode 620 is formed in a predetermined pattern on the planarization layer 550 and a portion of the third insulating layer 540 and the planarization layer 550 that is etched. Thus a conduction path between the drain electrode 610 and the first electrode 620 is formed. A transparent base substrate 680 is formed separately from the front substrate 505, and a color filter layer 670 is formed on a lower surface 680a of the transparent base substrate 680. A second electrode 660 is formed on a lower surface 670a of the color filter layer 670, and a first alignment layer 630 and a second alignment layer 650 that align the liquid crystal layer 640 are formed on the surfaces of the first electrode 620 and the second electrode 660 facing each other. A first polarization layer 500 is formed on a lower surface of the front substrate 505 and a second polarization layer 690 is formed on a top surface 680b of the base substrate and a protection film 695 is formed on a top surface 690a of the second polarization layer. A spacer 560 which partitions the liquid crystal layer 640 is formed between the color filter layer 670 and the planarization layer 550.

The liquid crystal display device 700 operates as follows. An external signal controlled by the gate electrode 590, the source electrode 570, and the drain electrode 610 form a potential difference between the first electrode 620 and the second electrode 660, and the potential difference determines the alignment of the liquid crystal layer 640. According to the alignment of the liquid crystal layer 640, the visible light V supplied by the backlight unit 100 is blocked or transmitted. The light is transmitted through the color filter layer 670 and radiates color, thus realizing an image.

FIG. 17 illustrates a liquid crystal display 700 (especially a TFT-LCD), however, a non-emissive display device for the flat display apparatus of the present invention is not limited thereto.

The flat display apparatus employing the electron emission type backlight unit 100 according to aspects of the present invention has improved image brightness and longer life span since the electron emission type backlight unit 100 has improved brightness and longer life span.

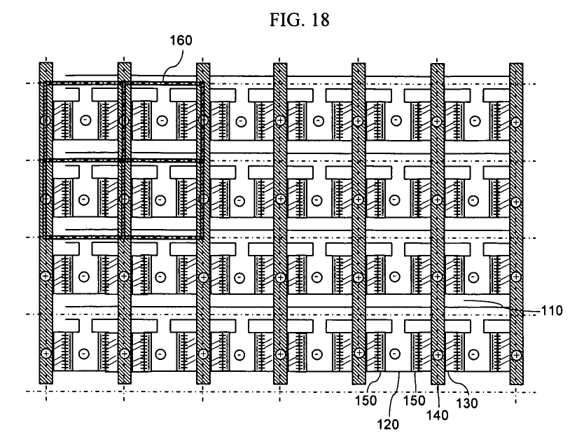

Also, as described above, the electron emission device having the above-described configuration can be used for an image display device according to an aspect of the invention. In this case, the electron emission device may have a structure, in which the gate electrode 140 and the cathode electrode 120 are formed in strips and cross each other, which is advantageous for applying signals to realize an image. For example, when the cathode electrode 120 is formed in strips extending in one direction, the gate electrode 140 may be formed of a main electrode crossing the cathode electrode 120 and a branch electrode extending from the main electrode to face the cathode electrode 120. The arrangement of the cathode electrode 120 and the gate electrode 140, of course, may be exchanged as shown in FIG. 18. When a color display device is realized, red, green, and blue light emitting phosphors are formed in the vacuum spaces 103 forming a unit pixel 160 under the anode electrode 80.

As described above, the cathode electrode and the gate electrode are formed extending toward the anode electrode such that an electric field of the anode electrode is prevented from interfering with the electric field between the cathode electrode and the gate electrode. Thus the anode electrode only accelerates the electrons and the gate electrode can easily control the electron emission, thereby obtaining light-emitting uniformity and maximizing the light-emitting efficiency of the phosphors.

Also, While not required in all aspects, curved surfaces, protrusions, or concaves are formed in the cathode electrode and the gate electrode, which are formed in strips, and thus the area of the electron emission layer is increased, thereby increasing the electron emitting efficiency.

Furthermore, when a backlight unit is formed using the electron emission device of an embodiment of the present invention, a display apparatus employing the backlight unit can have improved brightness and light-emitting efficiency.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electron emission device comprising:
a base substrate;
a cathode electrode formed on the base substrate and having a cross-section whose height is greater than its width;
a gate electrode formed on the base substrate and separated from the cathode electrode, and having a cross-section whose height is greater than its width; and
an electron emission layer disposed on a surface of the cathode electrode toward the gate electrode.

2. The electron emission device of claim 1, wherein the cathode electrode and the gate electrode are plural in number and alternately arranged on the base substrate.

3. The electron emission device of claim 1, wherein the electron emission layer is formed on both sides of the cathode electrode.

4. The electron emission device of claim 1, further comprising an insulating layer having a predetermined thickness and formed between the cathode electrode and the gate electrode.

5. The electron emission device of claim 4, wherein the height of the cathode electrode and the height of the gate electrode are substantially equal and the combined height of the insulating layer and the electron emission layer is substantially equal to the heights of the cathode electrode and the gate electrode.

6. The electron emission device of claim 5, wherein the height of the insulating layer is half the height of the cathode electrode.

7. The electron emission device of claim 4, wherein the height of the cathode electrode and the height of the gate electrode are substantially equal, the heights of the cathode electrode and the gate electrode are greater than the combined height of the insulating layer and the electron emission layer, wherein the electron emission layer is not formed in a portion of the upper end of the cathode electrode.

8. The electron emission device of claim 1, wherein the cathode electrode and the gate electrode are formed in strips.

9. The electron emission device of claim 1, wherein protrusions are formed to a predetermined length and width in the cathode electrode.

10. The electron emission device of claim 9, wherein the electron emission layer is formed on the protrusions.

11. The electron emission device of claim 9, wherein the protrusions are polygonal shaped.

12. The electron emission device of claim 9, wherein concaves corresponding to the protrusions in the cathode electrode are formed to a predetermined length and width in the gate electrode.

13. The electron emission device of claim 1, wherein a concave is formed to a predetermined length and width in the cathode electrode.

14. The electron emission device of claim 13, wherein the electron emission layer is formed on the concaves.

15. The electron emission device of claim 13, wherein the concaves are polygonal shaped.

16. The electron emission device of claim 13, wherein a protrusion corresponding to the concave formed in the cathode electrode is formed in the gate electrode.

17. The electron emission device of claim 1, wherein a curved surface with a predetermined curvature is formed in the cathode electrode.

18. The electron emission device of claim 17, wherein the electron emission layer is formed on the curved surface.

19. The electron emission device of claim 17, wherein the curved surface is convex toward the gate electrode.

20. The electron emission device of claim 17, wherein the curved surface is concave toward the gate electrode.

21. The electron emission device of claim 17, wherein a curved surface corresponding to the curved surface of the cathode electrode is formed in the gate electrode.

22. The electron emission device of claim 17, wherein both surfaces of the cathode electrode are curved and both curved surfaces are symmetrical around the center of the cathode electrode.

23. The electron emission device of claim 17, wherein the curved surface is formed continuously along the cathode electrode.

24. The electron emission device of claim 1, wherein the electron emission layer comprises an electron emission material selected from one of a group of carbon type materials comprising carbon nanotubes, graphite, diamond, and diamond-like carbon or one of a group of nano materials comprising nanotubes, nano wires, nanorods, nanoneedles, and combinations thereof.

25. The electron emission device of claim 1, wherein the electron emission layer is formed discontinuously at a side of the cathode electrode.

26. An electron emission type backlight unit comprising:
a front substrate comprising an anode electrode and a phosphor layer;
a base substrate separated from the front substrate by a predetermined distance;
a plurality of cathode electrodes that are formed on the base substrate, each of the cathode electrodes having a cross-section whose height is greater than its width;
a plurality of gate electrodes that are alternately formed on the base substrate and separated from the cathode electrodes, each of the gate electrodes having a cross-section whose height is greater than its width;
an electron emission layer formed on a side of each cathode electrode toward an adjacent one of the gate electrodes; and
a spacer maintaining a distance between the front substrate and the base substrate.

27. The electron emission type backlight unit of claim 26, wherein the phosphor layer is red, green, and blue light-emitting to form a unit pixel.

28. The electron emission type backlight unit of claim 26, wherein the height of the cathode electrodes and the height of the gate electrodes are substantially equal and the electron emission layer is not formed on a portion of the cathode electrodes toward the anode electrode.

29. The electron emission type backlight unit of claim 26, further comprising an insulating layer having a predetermined thickness and formed between each cathode electrode and the adjacent gate electrode.

30. The electron emission type backlight unit of claim 29, wherein the insulating layers and the electron emission layers are formed on both sides of the cathode electrodes.

31. The electron emission type backlight unit of claim 30, wherein the height of the cathode electrodes and the height of the gate electrodes are substantially equal, the heights of the cathode electrodes and the gate electrodes are greater than the combined height of each electron emission layer and the corresponding insulating layer, wherein the electron emission layers are not formed in a portion of the upper end of each cathode electrode.

32. The electron emission type backlight unit of claim 29, wherein the height of the cathode electrodes and the height of the gate electrodes are substantially equal, the heights of the cathode electrodes and the gate electrodes are greater than the combined height of each electron emission layer and the corresponding insulating layer, wherein the electron emission layers are not formed in a portion of the upper end of each cathode electrode.

33. The electron emission type backlight unit of claim 26, wherein the spacer is coated with a conductive material.

34. The electron emission type backlight unit of claim 26, wherein the front substrate and the base substrate are board members having respective predetermined thicknesses and formed of material selected from one of a group of a quartz glass, a glass including an impurity, a glass including a Na impurity, a borosilicate glass, a flat glass, and a glass substrate coated with SiO₂, an oxide aluminum substrate or a ceramic substrate.

35. The electron emission type backlight unit of claim 26, wherein the cathode electrodes and the gate electrodes are arranged in a striped pattern and cross each other, wherein:
the cathode electrodes have respective first branch electrodes extending to face the gate electrodes;
the gate electrodes have the first branch electrodes respectively extending to face the cathode electrodes; or
the cathode electrodes have the first branch electrodes respectively, and the gate electrodes have respective second branch electrodes extending to face the first branch electrodes of the cathode electrodes.

36. A flat display apparatus comprising:
an electron emission type backlight unit comprising:
a front substrate comprising an anode electrode and a phosphor layer,
a base substrate separated from the front substrate by a predetermined distance,
a plurality of cathode electrodes that are formed on the base substrate, each of the cathode electrodes having a cross-section whose height is greater than its width,
a plurality of gate electrodes that are alternately formed on the base substrate and separated from the cathode electrodes, each of the gate electrodes having a cross-section whose height is greater than its width,
an electron emission layer formed on a side of each cathode electrode toward the gate electrode, and
a spacer maintaining a distance between the front substrate and the base substrate; and
a non-emissive display device that is formed in front of the electron emission type backlight unit to control the light supplied from the electron emission device to realize an image.

37. The flat display apparatus of claim 36, wherein the non-emissive display device is a liquid display device.

38. The flat display device of claim 36, wherein the non-emissive display device comprises:
a front panel;
a buffer layer formed on the front panel;
a semiconductor layer formed on the buffer layer in a predetermined pattern;
a first display device insulating layer formed on the semiconductor layer;
a display device gate electrode formed in a predetermined pattern on the first display device insulating layer;
a second display device insulating layer formed on the display device gate electrode;
a source electrode formed on a predetermined area of the second display device insulating layer including an etched area of the first and second display device insulating layers where a portion of the semiconductor layer is exposed;
a drain electrode formed on another predetermined area of the second display device insulating layer including another etched area of the first and second display device insulating layers where another portion of the semiconductor layer is exposed;
a third display device insulating layer formed on the source electrode, the drain electrode, and the second display device insulating layer;
a planarization layer formed on the third display device insulating layer;
a first electrode formed on the planarization layer in a predetermined pattern, wherein a portion of the third display device insulating layer and the planarization layer is etched to create a conductive path between the drain electrode and the first electrode;
a transparent base substrate separated from the front panel;
a color filter layer formed on a first surface of the transparent base substrate;
a second electrode formed on a surface of the color filter layer opposite the transparent base substrate;
a liquid crystal layer;
a first alignment layer and a second alignment layer to align the liquid crystal layer, wherein the first alignment layer is formed on a surface of the first electrode opposite the planarization layer and the second alignment layer is formed on a surface of the second electrode opposite the color filter layer and on the surface of the color filter layer opposite the transparent base substrate not covered by the second electrode;
a first polarization layer formed on a surface of the front panel opposite the buffer layer;
a second polarization layer formed on a second surface of the transparent base substrate opposite the color filter layer;
a protection film formed on a surface of the second polarization layer opposite the transparent base substrate; and
a display device spacer formed between the color filter layer and the planarization layer to partition the liquid crystal layer.

39. The flat display device of claim 38, wherein
an external signal controlled by the display device gate electrode, the source electrode, and the drain electrode forms a potential difference between the first electrode and the second electrode and the potential difference determines the alignment of the liquid crystal layer to shield and transmit a visible light supplied by the backlight unit transmitted through the color filter layer to radiate color and realize an image.
